(19) United States
(12) Patent Application Publication
(10) Pub. No.: US 2026/0182566 A1
(43) Pub. Date: Jul. 2, 2026

(54) GRANULES AND BUILDING COMPONENT CONTAINING THE GRANULES

(71) Applicant: CERTAINTEED LLC, Malvern, PA (US)

(72) Inventors: Nicholas James WATKINS, Natick, MA (US); Hooman AMID, Worcester, MA (US); Hua WANG, Northbridge, MA (US); Siwar TRABELSI, Southborough, MA (US)

(21) Appl. No.: 19/435,870

(22) Filed: Dec. 30, 2025

Related U.S. Application Data
(60) Provisional application No. 63/740,391, filed on Dec. 31, 2024.

(51) Int. Cl. A01N 25/26; A01N 25/10; A01N 59/06; A01P 1/00; A01P 13/00; C09D 5/14

(52) U.S. Cl. CPC A01N 25/26; A01N 25/10; A01N 59/06; A01P 1/00; A01P 13/00; C09D 5/14

(57) ABSTRACT

In one embodiment, a granule can comprise a mixture, the mixture comprising an amorphous phase material and a biocidal agent including calcium oxide, wherein a 24-hour Ca²⁺ leaching factor change of the granule (24-LF Change) is at least 10%, the 24-LF Change=(24-LF_{G710}/24-LF_{G})×100%, with 24-LF_{G} being a 24 hour Ca²⁺ leaching factor of the granule and 24-LF_{G710} being a 24 hour leaching factor of the granule after subjecting the granule to sintering for 3 hours at a temperature of 710° C. In another embodiment, the granule can comprise a 24-hour Ca²⁺ Leaching Factor (LF_{G}) of not greater than 1700 ppm. The granule can be essentially free of a copper compound, a silver compound, and a zinc compound, and can be implemented in a building component with long time biocidal activity.

### CROSS-REFERENCE TO RELATED APPLICATION(S)

This Application claims priority under 35 U.S.C. § 119(e) to U.S. Provisional Patent Application No. 63/740,391, entitled “GRANULES WITH ANTIMICROBIAL REDUCTION ACTIVITY AND BUILDING COMPONENT CONTAINING THE GRANULES,” filed Dec. 31, 2024, by Nicholas James WATKINS et al., which is assigned to the current assignee hereof and is incorporated herein by reference in its entirety.

### FIELD OF THE DISCLOSURE

The present disclosure relates to granules, particularly granules for roofing materials, a method of making the granules, and a building component containing the granules.

### BACKGROUND

Roofing materials are susceptible to infestation of various microorganisms, such as fungi, bacteria, and algae, which can result in undesirable dark streaks on roofing surfaces. Attempted solutions to inhibit or delay the growth of microorganisms are typically only effective for a few years, usually less than ten years. There exists a need for improved biocidal roofing materials.

### BRIEF DESCRIPTION OF THE DRAWINGS

The present disclosure may be better understood, and its numerous features and advantages made apparent to those skilled in the art by referencing the accompanying drawings.

FIG. 1 includes a line drawing illustrating a cross-cut through a granule according to one embodiment.

FIG. 2A includes a line drawing illustrating a cross-cut through a granule according to one embodiment.

FIG. 2B includes a line drawing illustrating a cross-cut through a granule according to one embodiment.

FIG. 2C includes a line drawing illustrating a cross-cut through a granule according to one embodiment.

FIG. 3 includes a graph showing an X-ray spectra of the calcium oxide enriched glass used as starting compound for the coating of the granule, and after heating at 710° C.

FIG. 4 includes a line drawing illustrating a cross-cut through a building component according to one embodiment.

FIG. 5A includes a line drawing illustrating a cross-cut through a building component according to one embodiment.

FIG. 5B includes a line drawing illustrating a cross-cut through a building component according to one embodiment.

FIG. 6 includes an illustration of a test shingle subjected to an algae growth chamber test according to according to one embodiment.

FIG. 7 includes a line drawing for illustrating an algae growth chamber.

FIG. 8 includes a graph illustrating the measured humidity, temperature, and radiation energy within the algae growth chamber over a time of three days.

FIG. 9 includes a graph illustrating the change in delta E over a time period of 90 days for a test shingle sample and reference test shingles according to one embodiment.

### SUMMARY OF INVENTION

In one embodiment, a granule can comprise a mixture, the mixture comprising an amorphous phase material and a biocidal agent including calcium oxide, wherein a 24-hour Ca²⁺ leaching factor change of the granule (24-LF Change) is at least 10%, the 24-LF Change=(24-LF_{G710}/24-LF_{G})×100%, with 24-LF_{G} being a 24 hour Ca²⁺ leaching factor of the granule and 24-LF_{G710} being a 24 hour leaching factor of the granule after subjecting the granule to sintering for 3 hours at a temperature of 710° C.

In another embodiment, a granule can comprise a mixture, the mixture comprising an amorphous phase material and a biocidal agent including calcium oxide, wherein the granule may comprise a 24-hour Ca²⁺ Leaching Factor (LF_{G}) of not greater than 1700 ppm.

In a further embodiment, a method of forming a granule can comprise: preparing a green granule mixture, the green granule mixture comprising an amorphous phase material and a biocidal agent including calcium oxide; forming a green granule body from the green granule mixture; and heating the green granule body to form the granule, wherein the granule comprises a 24-hour Ca²⁺ Leaching Factor of not greater than 1700 ppm.

In yet a further embodiment, a method of forming a granule can comprise: providing a granule core; coating the granule core with a coating composition comprising an amorphous phase material and a biocidal agent including calcium oxide to form a coated green granule body; and heating the coated green granule body to form the granule, wherein the granule comprises a 24-hour Ca²⁺ Leaching Factor of not greater than 1700 ppm.

In another embodiment, a building component can comprise: a support layer; an organic coating layer overlying the support layer; and a plurality of granules attached to the organic coating layer, wherein at least 10 vol % of the plurality of granules comprise a mixture, the mixture comprising an amorphous phase material and a biocidal agent including calcium oxide, and wherein the building component has an algae growth factor 90 (AGF 90) of between −50% and 30% according to a test in an algae growth chamber, with AGF 90=((delta E 90_{S}/delta E 90_{b-ref})−1)×100%, wherein delta E 90_{S} is delta E of the building component after 90 days exposure in the algae growth chamber, and delta E 90_{b-ref} is delta E of a biocidal test reference after 90 days exposure in the algae growth chamber, wherein 10 vol % of a plurality of granules of the biocidal test reference are granules containing 3.5 wt % Cu₂O as a biocidal agent.

In a further embodiment, a building component can comprise: a support layer; an organic layer overlying the support layer; and a plurality of granules attached to the organic coating layer, wherein at least 10 vol % of the plurality of granules comprise a mixture, the mixture comprising an amorphous phase material and a biocidal agent including calcium oxide, and wherein the at least 10 vol % of the plurality of granules comprise a 24-hour Ca2+ leaching factor of not greater than 1700 ppm.

In yet another embodiment, a method of forming a building component can comprise: applying on a support layer an organic coating layer; attaching to the organic coating layer a plurality of granules, wherein at least 10 vol % of the plurality of granules comprise a mixture, the mixture comprising an amorphous phase material and a biocidal agent including calcium oxide, and wherein the at least 10 vol % of the plurality of granules comprise a 24-hour Ca²⁺ leaching factor of not greater than 1700 ppm.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Various embodiments of the present disclosure will now be described, by way of example only, with reference to the accompanying drawings.

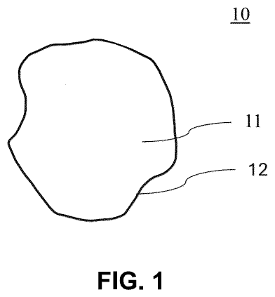

In one embodiment, as illustrated in FIG. 1, the present disclosure is directed to a granule (10) having a body (11) and an outer surface of the body (12). The material of the body of the granule may be a mixture comprising an amorphous phase material and a biocidal agent including calcium oxide.

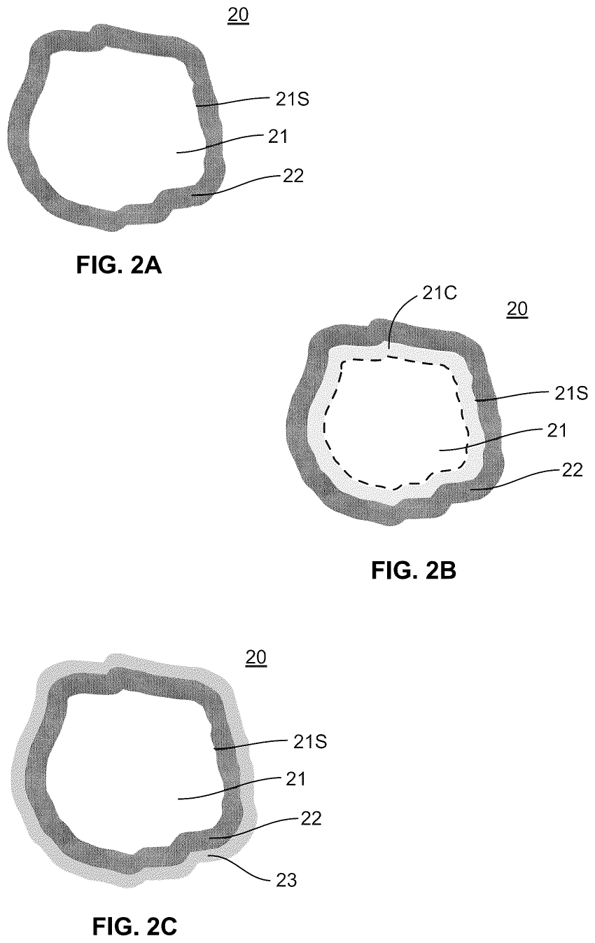

In another embodiment, as illustrated in FIG. 2A, the present disclosure is directed to a granule 20 comprising a core (21) and a first coating (22) overlying an outer surface the core (21S), wherein the first coating (22) can comprise a mixture, the mixture including an amorphous material and an antimicrobial agent including calcium oxide. FIG. 2B illustrates an aspect of the coated granule (20), wherein the granule core (21) of the granule contains a coating (21C), which is considered being part of the granule core. FIG. 2C illustrates a further aspect of the coated granule (20), wherein above the first coating (22) lies a second outer coating (23).

In a particular aspect, the calcium oxide contained in the granules of the present disclosure can be part of the amorphous phase material, which can be, for example, a glass.

As used herein, if not indicated otherwise, the term “granule” relates to the granules illustrated by in FIG. 1 or FIG. 2A, 2B, or 2C.

Furthermore, as used herein, the term “granule,” if not indicated otherwise, also includes the plural form “granules.”

As further used herein, the term “amorphous phase material” relates to an inorganic oxide material which is at least to 70% amorphous, meaning that not more than 30% are crystalline. In a certain aspect, the crystallinity of the amorphous phase material may be not greater than 25%, or not greater than 20%, or not greater than 15%, or not greater than 10%, or not greater than 5%, or not greater than 3%, or not greater than 1%, or the amorphous phase material can be fully amorphous (0% crystalline, 100% amorphous). In a certain aspect, the crystallinity or the amorphous phase material may be not greater than 10%.

It has been surprisingly found that the granules of the present disclosure can have a low leaching of calcium ions (Ca²⁺) in water, and that the Ca²⁺ ion leaching can increase by at least 10% if the granules are subjected to a sintering treatment at 710° C.

As used herein, the Ca²⁺ ion leaching is expressed as leaching factor (LF). The leaching factor (LF) corresponds to the amount of Ca²⁺ ions released by conducting a defined leaching test, and expresses the amount of leached Ca²⁺ ions in ppm based on 1 gram of the granules.

As further used herein, the 24-hour Ca²⁺ leaching factor change (24-LF Change) expresses the percent of increase of the leaching factor after subjecting the granules to a sintering treatment at 710° C. The 24-LF Change is calculated according to equation (1): 24-LF=(24-LF_{G710}/24-LF_{G})×100% (1), wherein 24-LF_{G} is the 24 hour Ca²⁺ leaching factor of the granules, and 24-LF_{G710} is the 24 hour leaching factor of the granules after subjecting the granules to sintering, wherein the sintering includes three hours sintering at 650° C. followed by three hours sintering at a temperature of 710° C.

Not being bound to theory, the reason for the higher leaching of Ca²⁺ ions after sintering at 710° C. can be the conversion of the amorphous phase material to a crystalline phase material during the sintering, wherein the crystalline phase material allows an easier release of the Ca²⁺ ions.

In one aspect, the 24-LF Change of the granules of the present disclosure can be at least 10%, or at least 50%, or at least 100%, or at least 200%, or at least 300%, or at least 500%, or at least 800%, or at least 1000%. In another aspect, the 24-LF Change may be not greater than 12,000%, or not greater than 10,000%, or not greater than 5,000%, or not greater than 1000%, or not greater than 500%.

In another embodiment, the granule of the present disclosure can comprise a 24-hour Ca²⁺ Leaching Factor (LF_{G}) of not greater than 1700 ppm, or not greater than 1650 ppm, or not greater than 1500 ppm, or not greater than 1400 ppm, or not greater than 1300 ppm, or not greater than 1200 ppm, or not greater than 1100 ppm, or not greater than 1000 ppm, or not greater than 900 ppm, or not greater than 800 ppm, or not greater than 700 ppm, or not greater than 600 ppm, or not greater than 500 ppm, or not greater than 400 ppm, or not greater than 300 ppm. In another aspect, the 24-hour Ca²⁺ Leaching Factor may be at least 1 ppm, at least 5 ppm, or at least 10 ppm, or at least 20 ppm, or at least 40 ppm, or at least 60 ppm, or at least 80 ppm, or at least 100 ppm. In a certain particular aspect, the 24-hour LF_{G} may be not greater than 500 ppm.

In a further aspect, the granule of the present disclosure can comprise a 72-hour Ca²⁺ Leaching Factor of not greater than 3500 ppm, or not greater than 3000 ppm, or not greater than 2800 ppm, or not greater than 2500 ppm, or not greater than 2200 ppm, or not greater than 2000 ppm, or not greater than 1800 ppm, or not greater than 1500 ppm, or not greater than 1200 ppm, or not greater than 1000 ppm, or not greater than 800 ppm. In another aspect, the 72-hour Ca²⁺ Leaching Factor may be at least 10 ppm, or at least 50 ppm, or at least 100 ppm, or at least 200 ppm, or at least 300 ppm.

In yet another aspect, the granule of the present disclosure may have a 264-hour Ca²⁺ Leaching Factor of not greater than 4000 ppm, or not greater than 3500 ppm, or not greater than 3000 ppm based, or not greater than 2800 ppm, or not greater than 2500 ppm, or not greater than 2200 ppm, or not greater than 2000 ppm, or not greater than 1800 ppm, or not greater than 1500 ppm, or not greater than 1200 ppm. In another aspect, the 264-hour Ca²⁺ Leaching Factor may be at least 100 ppm, or at least 150 ppm, or at least 200 ppm, or at least 500 ppm, or at least 800 ppm.

The leaching factor can be also expressed in mg leached Ca²⁺ ions/g granules. For example the 24-hour Ca²⁺ leaching factor of not greater than 1700 ppm converts to not greater than 1.7 mg Ca²⁺ ions/gram granules (LF of 1700 ppm=1.7 mg/g).

In another embodiment, the granule can have a Ca²⁺ Leaching Factor Difference of not greater than 1000 ppm, wherein the Ca²⁺ Leaching Factor Difference is measured as a difference in value between a 72-hour Ca²⁺ Leaching Factor and a Ca²⁺ 24-hour Leaching Factor. In certain aspects, the Ca²⁺ Leaching Factor Difference may be not greater than 900 ppm, or not greater than 800 ppm, or not greater than 700 ppm, or not greater than 600 ppm, or not greater than 500 ppm.

The majority of the biocidal agent contained in the granule can be calcium oxide. In a certain aspect, at least 80 wt % of the biocidal agent can be calcium oxide based on the total weight of biocidal agent, or at least 85 wt %, or at least 90 wt %, or at least 95 wt %, or at least 98 wt %, or at least 99 wt %, or all the biocidal agent can be calcium oxide.

In one aspect, the granule containing calcium oxide as biocidal agent can be essentially free of a copper compound, for example copper oxide, or a water-soluble copper compound. As used herein, essentially free of a copper compound means that an amount of copper compounds is not greater than 2 wt % based on the total weight of the granule, or not greater than 1 wt %, or not greater than 0.5 wt %, or not greater than 0.1 wt %. In a particular aspect, the granule can be free of a copper compound.

In another aspect, the granule of the present disclosure may be essentially free of a silver compound, for example, silver oxide. As used herein, essentially free of a silver compound means that the amount of the silver compound is not greater than 0.1 wt % based on the total weight of the granule, or not greater than 0.05 wt %, or not greater than 0.01 wt %. In a certain aspect, the granule can be free of a silver compound.

In yet a further aspect, the granule of the present disclosure can be essentially free of a zinc compound, for example zinc oxide. As used herein, essentially free of a zinc compound means that an amount of zinc compounds is not greater than 3 wt %, or not greater than 2 wt %, or not greater than 1 wt %, or not greater than 0.5 wt %. In a particular aspect, the granule can be free of a zinc compound.

In a particular aspect, the granule of the present disclosure can be essentially free of a copper compound, and essentially free of a silver compound, and essentially free of a zinc compound. In a certain particular aspect, the granule can be free of a copper compound, free of a silver compound, and free of a zinc compound.

In a further aspect, the granule of the present disclosure can have an antimicrobial reduction activity according to ASTM E2149 of at least 70%, or at least 80%, or at least 85%, or at least 90%, or at least 95%, or at least 96%, or at least 97%, or at least 98%. In another aspect, the antimicrobial reduction activity of the granule may be not greater than 99.5%, or not greater than 99%.

In one aspect, the above described granule of the present disclosure can be a roofing granule.

The size of the granule of the present disclosure (largest diameter) can be at least 1 micron, or at least 3 microns, or at least 5 microns, or at least 10 microns, or at least 20 microns, or at least 40 microns, or at least 60 microns, or at least 100 microns, or at least 400 microns mm, or at least or at least 600 mm, or at least 800 microns, or at least 1000 microns, or at least 1500 microns, or at least 2000 microns. In another aspect, the size of the granule may be not greater than 50 mm, or not greater than 30 mm, or not greater than 20 mm, or not greater than 10 mm, or not greater than 5.0 mm, or not greater than 4.0 mm, or not greater than 3.5 mm, or not greater than 3.0 mm, or not greater than 2.5 mm, or not greater than 2.0 mm.

In a further aspect, the present disclosure is directed to a plurality of granules, wherein each granule of the plurality of granules can have the structure of the granule shown in FIG. 1 or FIGS. 2A, 2B, 2C and described herein.

In a particular aspect, the plurality of granules can have an average particle size (D50) measured by laser diffraction of at least 5 microns, or at least 10 microns, or at least 20 microns, or at least 40 microns, or at least 70 microns, or at least 100 microns, or at least 400 microns, or at least or at least 600 microns, or at least 800 microns, or at least 1000 microns, or at least 1500 microns, or at least 2000 microns. In another aspect, the average particle size of the plurality of granules may be not greater than 50 mm or not greater than 30 mm or not greater than 20 mm or not greater than 10 mm or not greater than 5.0 mm or not greater than 4.0 mm, or not greater than 3.5 mm, or not greater than 3.0 mm, or not greater than 2.5 mm, or not greater than 2.0 mm, or not greater than 1 mm. In a particular aspect, the D50 size of the plurality of granules can be at least 550 microns and not greater than 1800 microns.

In one embodiment, a method of forming the granule (10) shown in FIG. 1 can comprise: i) forming a green granule mixture containing the amorphous phase material including calcium oxide as biocidal agent; ii) forming green granules from the green granule mixture; and iii) heating of the green granules. The heating may be conducted by firing the green granules at a temperature of at least 200° C., or at least 300° C., or at least 350° C., or at least 400° C., or at least 450° C., or at least 500° C. In another aspect, the firing may be conducted at a temperature not greater than 600° C., or not greater than 570° C., or not greater than 550° C. In a certain aspect, the firing temperature can be at least 300° C. and not greater than 570° C. As used herein, firing means heating treating the granules for 30 minutes in a kiln which has already been heated to the firing temperature before the granules are added.

In one aspect, the amorphous phase material of the granule (10) containing the calcium oxide can consist essentially of a glass, wherein at least 70% of the glass may be amorphous. In a particular aspect, at least 80% of the glass can be amorphous, or at least 85%, or at least 90%, or at least 94%, or at least 96%, or at least 98%, or the glass may be fully amorphous.

In another aspect, the granule (10) can comprise a mixture of the glass containing CaO as biocidal agent and one or more other additives. Non-limiting examples of other additives can be sodium silicate, clay, titanium dioxide, aluminum trihydrate, or other types of pigments.

In a particular aspect, the granule (10) can further comprise an outer coating (not shown) overlying the surface (12), wherein the outer coating can include a polymer, a dye, or a pigment and may be free of a biocidal agent.

In another particular aspect, the surface (12) of the body (11) of the granule (10) may be free of a coating.

In a further embodiment, a method of forming the coated granule (20) with the structure as illustrated in FIGS. 2A, 2B, and 2C can comprise: i) providing a granule core particle (21), ii) coating the granule core particle with a coating composition comprising the amorphous phase material including calcium oxide to form a green coated granule, and iii) heating the green coated granule to form the coating (22) attached to the granule core (21). As used herein, the coating layer (22) overlying the granule core (21) is also called interchangeable “first coating.” FIG. 2A illustrates a granule containing a granule core particle (21) and the first coating (22).

The granule core particle (21) can be a mineral particle or a ceramic particle typically used for making a roofing granule, such as talc, slag, limestone, granite, syenite, diabase, greystone, slate, trap rock, basalt, greenstone, andesite, porphyry, and rhyolite, or other naturally occurring metamorphic rock, a ceramic particle, a coated ceramic particle, ceramic-coated base rock, sand, or gravel. If the base rock particle or ceramic particle is coated with a ceramic and/or pigments, as illustrated in FIG. 2B, such coating (21C) is considered herein part of the granule core (21), wherein the granule core ends with the surface (21S).

In another aspect, various types of stone dust can also be employed to prepare the core particles. Stone dust is a natural aggregate produced as a by-product of quarrying, stone crushing, machining operations, and similar operations. In yet another aspect, the core particles can also include a ceramic-forming material, for example, an aluminosilicate. Any reasonable aluminosilicate, such as a bauxite, may be envisioned. The ceramic-forming material can further include uncalcined, partially calcined, or calcined clay. In addition to the at least one aluminosilicate, the ceramic-forming material can include small amounts of other minerals.

In a particular aspect, the granule core (21) of the granule (20) can be essentially free of calcium oxide. As used herein, essentially free of calcium oxide means that an amount of calcium oxide is not greater than 5 wt % based on the total weight of the granule core, or not greater than 4 wt %, or not greater than 3 wt %, or not greater than 2 wt %, or not greater than 1 wt %, or not greater than 0.5 wt %, or not greater than 0.1 wt %.

In a further aspect, the granule core particle (herein also called just “granule core”) can have a particle size of at least 100 microns, or at least 200 microns, or at least 300 microns, or at least 500 microns, or at least 700 microns, or at least 1000 microns, or at least 1200 microns, or at least 1500 microns, or at least 2000 microns, or at least 2500 microns, or at least 3000 microns. In another aspect, the granule core may be not greater than 50 mm, or not greater than 40 mm, or not greater than 20 mm, or not greater than 10 mm, or not greater than 5 mm, or not greater than 3 mm, or not greater than 2 mm, or not greater than 1 mm.

The coating of the granule core particles (21) with the coating composition (step ii) can be conducted by a variety of methods, for example, pan coating, spray coating, fluidized bed coating, dip coating, powder coating, thin film coating, or any combination thereof. In a particular embodiment, the first coating (22) may be applied by pan coating. Pan coating includes placing the core particles in a viscous coating composition and agitating the particles therein until a coating is formed on the base particles.

The first coating (22) can directly overly the outer surface of the core particle (21S). In one aspect, the first coating (22) can overlay at least 50% of the outer surface of the core particle, or at least 75%, or at least 90%, or up to 100% of the outer surface. The percentage of the surface (21S) coated with the coating may depend on the method used to coat the core particle.

The first coating (22) may further include a variety of layers, wherein each layer can comprise the same or a different biocidal glass composition.

In one embodiment, the coating composition for forming the first coating (22) of the granule (20) can comprise next to calcium oxide as biocidal agent a variety of other compounds, including but not limited to alkali metal silicate, clay, titanium oxide, metal phosphate, aluminum hydrate, pigments, dyes, or any combination thereof.

In one aspect, the amount of the amorphous phase material containing the calcium oxide can be at least 10 wt % in the coating composition based on the dry weight of the coating composition, or at least 20 wt %, or at least 30 wt %, or at least 40 wt %, or at least 50 wt %, or at least 55 wt %, or at least 60 wt %. In another aspect, the amount of the amorphous CaO-containing glass may be not greater than 90 wt %, or not greater than 80 wt %, or not greater than 70 wt %, or not greater than 60 wt % based on the dry weight of the coating composition. Since these amounts are based on dry weight of the coating composition, they can also correspond to the amount of the CaO-containing amorphous glass in the first coating (22).

In another embodiment, the first coating (22) of the granule can comprise a polymer. In a particular aspect, the first coating can consist essentially of the polymer and the amorphous phase material including calcium oxide as biocidal agent. In non-limiting examples, the polymer in the coating (22) can be a silicone polymer, an acrylic polymer, a polyurethane, a polyolefin, a fluoropolymer, or any copolymer thereof. In a certain particular aspect, the polymer can be a silicone polymer, or a silicone copolymer, for example, a silicone-acrylic copolymer. Particular non-limiting examples polymers can be Dowsil IE-6710, Silres BS 6510, or Silres MPF 52E.

In another embodiment, as illustrated in FIG. 2C, the granule (20) can further comprise a second coating (23) overlying the first coating (22), wherein the second coating can include a polymer, or a dye, or a pigment, or any combination thereof. In a particular aspect, the second coating (23) of the granule (20) can include a polymer and being essentially free of a biocidal agent. As used herein, being essentially free of a biocidal agent means that an amount of a biocidal agent is not greater than 0.1 wt % based on the total weight of the respective outer coating. In another aspect, the second coating (23) can be free of a biocidal agent.

Non-limiting examples of the polymer contained in the second coating can be a silicone polymer, an acrylate polymer, a polyurethane, a polyolefin, a fluoropolymer, or any copolymer thereof. In a particular aspect, the polymer in the second coating can be a silicone polymer or a silicone copolymer.

In a particular embodiment, the coated granule (20) can comprise the first coating (22) and may be free of the second coating (23) described above.

Depending on the type of coating method, the coating composition can comprise water.

In aspects, the amount water in the coating composition can be at least 3 wt % based on the total weight of the coating composition, or at least 5 wt %, or at least 10 wt %, or at least 15 wt %, or at least 20 wt %. In another aspect, the amount of the water in the coating composition may be not greater than 50 wt %, or not greater than 30 wt %, or not greater than 20 wt %, or not greater than 15 wt % based on the total weight of the coating composition.

Once the coating is applied, the green granules can be subjected to heating by firing. The maximum temperature of the firing typically depends upon the type of the coating composition. In one embodiment, firing can be conducted in a rotary kiln at a temperature of at least 200° C., or at least 250° C., or at least 350° C., or at least 400° C., or at least 450° C., or at least 500° C., or at least 530° C. In another aspect, firing of the coated granule may be conducted at a temperature not greater than 650° C., or not greater than 600° C., or not greater than 570° C., or not greater than 550° C.

In the aspect that the first coating (22) comprises a polymer, the heating is called herein curing. The curing of may be conducted at a temperature of at least 60° C., or at least 80° C., or at least 100° C., or at least 130° C. In another aspect, curing may by conducted at a temperature not greater 300° C., or not greater than 250° C., or not greater than 200° C. or not greater than 150° C. In a certain aspect, if the coating composition containing the polymer is water-based, the curing can involve drying.

In a certain aspect, the first coating (22) can be a plurality of layers formed by repeated coating. The process of applying several coating layers can be repeated any number of times until a desired thickness and weight % of CaO-enriched glass is reached in the combined coating layers.

In one embodiment, the first coating (22) of the granule (20) can comprise calcium oxide as biocidal agent in an amount of at least 3 wt % based on the total weight of the coating, or at least 5 wt %, or at least 7 wt %, or at least 9 wt %, or at least 10 wt %, or at least 12 wt %, or at least 15 wt %, or at least 18 wt %, or at least 20 wt %. In another aspect, the amount of calcium oxide in the coating (22) may be not greater than 30 wt % based on the total weight of the coating, or not greater than 25 wt %, or not greater than 20 wt %, or not greater than 18 wt %, or not greater than 15 wt %.

In one aspect, the first coating (22) of the granule (20) can have a crystallinity of not greater than 30%, or not greater than 20%, or not greater than 10%, or not greater than 5%, or not greater than 3%, or not greater than 1%, or 0% (being fully amorphous).

In one embodiment, the first coating (22) of the granule (20) can have an average thickness of at least 0.5 microns, or at least 1 micron, or at least 5 microns, or at least 8 microns, or at least 10 microns, or at least 15 microns, or at least 20 microns, or at least 30 microns, or at least 40 microns. In another aspect, the average thickness of the coating may be not greater than 200 microns, or not greater than 150 microns, or not greater than 100 microns, or not greater than 80 microns, or not greater than 70 microns, or not greater than 60 microns. In a particular aspect, the thickness of the first coating is between 30 microns and 40 microns. The average thickness of the coating may be a number between any of the minimum and maximum numbers noted above.

The present disclosure is further directed to a building component, for example, a shingle or a board.

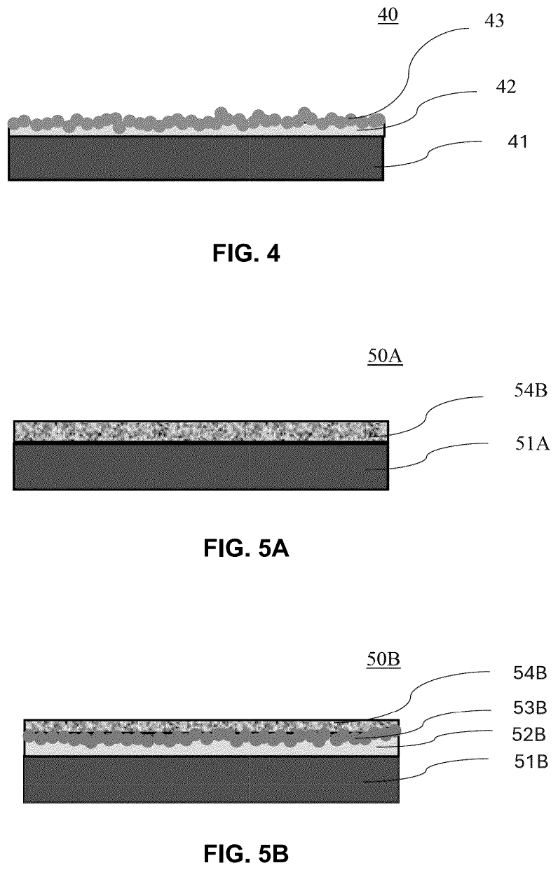

In one embodiment, as illustrated in FIG. 4, the building component (40) can comprise a support layer (41); an organic coating layer overlying the support layer (42); and a plurality of granules attached to the organic coating layer (43), and at least 10 vol % of the plurality of granules can be the above-described granules illustrated in FIG. 1 or FIGS. 2A, 2B, and 2C.

The building component can have a biocidal activity. As demonstrated in the examples by conducting an algae growth chamber test, the building component of the present disclosure can reduce the growth of algae under simulated long term exposure to outside weather conditions.

In one aspect, the biocidal activity of the building component can be expressed by the algae growth factor 90 (AGF 90). The AGF 90 is calculated herein by equation 2: AGF 90=((delta E 90_{S}/delta E 90_{b-ref})−1)×100% (2), wherein delta E 90_{S} is delta E after 90 days exposure of a test shingle of the building component in an algae growth chamber, and delta E 90_{b-ref} is delta E after 90 days exposure of a test reference shingle comprising 10 vol % granules containing 3.5 wt % Cu₂O as a biocidal agent.

In one aspect, the AGF 90 can be at least −50%, or at least −40%, or at least −30%, or at least −20%, or at least −10%, or at least 1%, or at least 5%, or at least 10%, or at least 15%, or at least 20%. In a further aspect, the AGF 90 may be not greater than 30%, or not greater than 28%, or not greater than 25%.

In another aspect, the building component can have an E. coli reduction activity of at least 90% according to ASTM E2180.

In a further aspect, the building component can have a S. aureus reduction activity of at least 95% according to ASTM E2180.

In a certain aspect, the layer of the plurality of granules of the building component can comprises a first plurality of granules and a second plurality of granules, wherein the first plurality of granules may be the above described granules of the present disclosure, and the second plurality of granules can be common roofing granules not containing a biocidal agent. In one aspect, a weight % ratio of the first plurality of roofing granules to the second plurality of roofing granules may be not greater than 1:1, or not greater than 1:2, or not greater than 1:3, or not greater than 1:5, or not greater than 1:8, or not greater than 1:10, or not greater than 1:15. In another aspect, the weight % ratio of the first plurality of granules to the second plurality of granules may be at least 1:20, or at least 1:10.

The building component illustrated in FIG. 4 may be an asphalt-based shingle comprising the roofing granule of the present disclosure described above.

In another embodiment, as illustrated in FIG. 5A, a building component (50A) can comprise a support layer (51A) and a functional layer (54A) overlying the support layer, wherein the functional layer (54A) can comprises an amorphous phase material and a biocidal agent including calcium oxide. In one aspect the functional layer can be the material of the first coating (22) described above with regard to the coated granules (20). In a particular aspect, the building component shown in FIG. 5A can be a building board.

In a further aspect, as illustrated in FIG. 5B, the building component (50B) may comprise between the support layer (50B) and the functional layer (54B) an organic coating layer (53B) directly overlying the support layer (51B), and a layer of a plurality of granules (53B) attached to the organic coating layer (52B).

In one aspect, the granules shown in layer 53B of FIG. 5B can be common roofing granules without containing a biocidal agent. In another aspect, the granules of layer 53B may contain the roofing granule (10) or (20) of the present disclosure in combination with granules not containing a biocidal agent, as described for the embodiment shown in FIG. 4.

In a certain aspect, the functional layers 54A or 54B can contain a polymer, for example a silicone polymer or a silicone copolymer, for example a silicone-acrylic copolymer, and the calcium oxide containing amorphous phase material.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A granule, the granule comprising a mixture, the mixture comprising an amorphous phase material and a biocidal agent including calcium oxide, wherein a 24-hour Ca²⁺ leaching factor change of the granule (24-LF Change) is at least 10%, the 24-LF Change=(24−LF_{G710}/24-LF_{G})×100%, with 24-LF_{G} being a 24 hour Ca²⁺ leaching factor of the granule and 24-LF_{G710} being a 24 hour leaching factor of the granule after subjecting the granule to sintering for 3 hours at a temperature of 710° C.

Embodiment 2. A granule, the granule comprising a mixture, the mixture comprising an amorphous phase material and a biocidal agent including calcium oxide, wherein the granule comprises a 24-hour Ca²⁺ Leaching Factor (LF_{G}) of not greater than 1700 ppm.

Embodiment 3. The granule of embodiments 1 or 2, wherein the granule comprises a granule core and a first coating overlying the granule core, and wherein the first coating comprises the mixture comprising the amorphous phase material and the biocidal agent including calcium oxide.

Embodiment 4. The granule of any one of embodiments 1-3, wherein the calcium oxide is a part of the amorphous phase material.

Embodiment 5. The granule of any one of the preceding embodiments, wherein a size of a largest diameter of the granule is at least 1 micron, or at least 3 microns, or at least 5 microns, or at least 10 microns, or at least 20 microns, or at least 40 microns, or at least 60 microns, or at least 100 microns, or at least 400 microns mm, or at least or at least 600 mm, or at least 800 microns, or at least 1000 microns mm, or at least 1500 microns, or at least 2000 microns.

Embodiment 6. The granule of any one of the preceding embodiments, wherein a size of a largest diameter of the granule is not greater than 50 mm, or not greater than 30 mm, or not greater than 20 mm, or not greater than 10 mm, or not greater than 5.0 mm, or not greater than 4.0 mm, or not greater than 3.5 mm, or not greater than 3.0 mm, or not greater than 2.5 mm, or not greater than 2.0 mm, or not greater than 1.0 mm.

Embodiment 7. The granule of any one of the preceding embodiments, wherein the granule is essentially free of a copper compound.

Embodiment 8. The granule of any one of the preceding embodiments, wherein the granule is essentially free of a silver compound.

Embodiment 9. The granule of any one of the preceding embodiments, wherein the granule is essentially free of a zinc compound.

Embodiment 10. The granule of any one of the preceding embodiments, wherein the granule is essentially free of a copper compound, essentially free of a silver compound, and essentially free of a zinc compound.

Embodiment 11. The granule of any one of the preceding embodiments, wherein the amorphous phase material includes a silica-based glass containing the calcium oxide.

Embodiment 12. The granule of any one of the preceding embodiments, wherein the granule comprises an antimicrobial reduction activity according to ASTM E2149 of at least 90%, or at least 95%, or at least 96%, or at least 97%, or at least 98%, or at least 99%.

Embodiment 13. The granule of embodiment 1, wherein the 24-hour LF Change is at least 50%, or at least 100%, or at least 200%, or at least 300%, or at least 500%, or at least 800%, or at least 1000%.

Embodiment 14. The granule of embodiment 1, wherein the 24-hour LF Change is not greater than 15,000%, or not greater than 12,000%, or not greater than 10,000%, or not greater than 5,000%, or not greater than 1000%, or not greater than 500%.

Embodiment 15. The granule of any one of the preceding embodiments, wherein the 24-hour LF_{G} corresponds to a Ca²⁺ weight loss of the granule of not greater than 10.5 wt % based on a total weight of Ca²⁺ in the granule, or not greater than 10.0 wt %, or not greater than 8.0 wt %, or not greater than 6.0 wt %, or not greater than 4.0 wt %, or not greater than 3.0 wt %, or not greater than 2.5 wt %, or not greater than 2.0 wt %, or not greater than 1.5 wt %.

Embodiment 16. The granule of any one of the preceding embodiments, wherein the 24-hour LF_{G} corresponds to a Ca²⁺ weight % loss of the granule of at least 0.1 wt % based on a total weight of Ca²⁺ in the granule, or at least 0.2 wt %, or at least 0.5 wt %, or at least 1 wt %.

Embodiment 17. The granule of any one of the preceding embodiments, wherein the granule comprises a 24-hour Ca²⁺ Leaching Factor of not greater than 1700 ppm, or not greater than 1650 ppm, or not greater than 1500 ppm, or not greater than 1400 ppm, or not greater than 1300 ppm, or not greater than 1200 ppm, or not greater than 1100 ppm, or not greater than 1000 ppm, or not greater than 900 ppm, or not greater than 800 ppm, or not greater than 700 ppm, or not greater than 600 ppm, or not greater than 500 ppm, or not greater than 400 ppm, or not greater than 300 ppm.

Embodiment 18. The granule of embodiment 17, wherein the 24-hour Ca²⁺ Leaching Factor is at least 1 ppm, at least 10 ppm, or at least 20 ppm, or at least 40 ppm, or at least 60 ppm, or at least 80 ppm, or at least 100 ppm.

Embodiment 19. The granule of any one of the preceding embodiments, wherein the granule comprises a 72-hour Ca²⁺ Leaching Factor of not greater than 3500 ppm, or not greater than 3000 ppm, or not greater than 2800 ppm, or not greater than 2500 ppm, or not greater than 2200 ppm, or not greater than 2000 ppm, or not greater than 1800 ppm, or not greater than 1500 ppm, or not greater than 1200 ppm, or not greater than 1000 ppm, or not greater than 800 ppm.

Embodiment 20. The granule of embodiment 19, wherein the 72-hour Ca²⁺ Leaching Factor is at least 10 ppm, or at least 50 ppm, or at least 100 ppm, or at least 200 ppm, or at least 300 ppm.

Embodiment 21. The granule of any one of the preceding embodiments, wherein the granule comprises a 264-hour Ca²⁺ Leaching Factor of not greater than 4000 ppm, or not greater than 3500 ppm, or not greater than 3000 ppm, or not greater than 2800 ppm, or not greater than 2500 ppm, or not greater than 2200 ppm, or not greater than 2000 ppm, or not greater than 1800 ppm, or not greater than 1500 ppm, or not greater than 1200 ppm.

Embodiment 22. The granule of embodiment 21, wherein the 264-hour Ca²⁺ Leaching Factor is at least 100 ppm, or at least 150 ppm, or at least 200 ppm, or at least 500 ppm, or at least 800 ppm.

Embodiment 23. The granule of any one of the preceding embodiments, further comprising a Ca²⁺ Leaching Factor Difference of not greater than 1000 ppm by weight, wherein the Ca²⁺ Leaching Factor Difference is measured as a difference in value between a 72-hour Ca²⁺ Leaching Factor and a Ca²⁺ 24-hour Leaching Factor, wherein the Ca²⁺ Leaching Factor Difference is not greater than 900 ppm, or not greater than 800 ppm, or not greater than 700 ppm, or not greater than 600 ppm, or not greater than 500 ppm.

Embodiment 24. The granule of embodiment 23, wherein the Ca²⁺ Leaching Factor Difference is at least 10 ppm, or at least 50 ppm, or at least 100 ppm.

Embodiment 25. The granule of any one of the preceding embodiments, wherein the mixture further comprises an additive selected from sodium silicate, clay, titanium dioxide, aluminum trihydrate, a pigment, a dye, a dispersant, or any combination thereof.

Embodiment 26. The granule of embodiment 24, wherein an amount of the additive is at least 1 wt % based on the total weight of the mixture, or at least 5 wt %, or at least 10 wt %, or at least 20 wt %, or at least 30 wt %, or at least 40 wt %, or at least 50 wt %, or at least 55 wet %, or at least 60 wt %, or at least 65 wt %, or at least 70 wt %.

Embodiment 27. The granule of embodiment 25, wherein the amount of the additive is not greater than 90 wt %, based on the total weight of the mixture, or not greater than 80 wt %, or not greater than 70 wt %, or not greater than 60 wt %, or not greater than 50 wt %, or not greater than 40 wt %, or not greater than 30 wt %, or not greater than 20 wt %, or not greater than 10 wt %.

Embodiment 28. The granule of any one of the preceding embodiments, wherein an amount of the calcium oxide is not greater than 35 wt % based on the total weight of the mixture, or not greater than 30 wt %, or not greater than 25 wt %, or not greater than 20 wt %, or not greater than 15 wt %, or not greater than 12 wt %, or not greater than 10 wt %.

Embodiment 29. The granule of any one of the preceding embodiments, wherein an amount of the calcium oxide is at least 3 wt % based on the total weight of the mixture, or at least 5 wt %, or at least 7 wt %, or at least 10 wt %, or at least 12 wt %, or at least 15 wt %, or at least 18 wt %, or at least 19 wt %, or at least 20 wt %.

Embodiment 30. The granule of any one of the preceding embodiments, wherein the mixture has a total crystallinity of not greater than 30%, or not greater than 20%, or not greater than 15%, or not greater than 10%, or not greater than 5%, or not greater than 2%, or not greater than 1%.

Embodiment 31. The granule of any one of the preceding embodiments, wherein the mixture has a total crystallinity of at least 1%, or at least 2%, or at least 5%.

Embodiment 32. The granule of any one of embodiments 1-31, wherein the mixture is fully amorphous.

Embodiment 33. The granule of any one of embodiments 3-31, wherein the granule core comprises a ceramic particle or a mineral base rock particle.

Embodiment 34. The granule of embodiment 33, wherein a material of the mineral base rock particle is selected from rhyolite, nepheline syenite, slate, basalt, andesite, dacite, diabase, granite, or any combination thereof.

Embodiment 35. The granule of embodiments 33 or 34, wherein the granule core further comprises a pigment coating overlying the ceramic particle or mineral base rock particle.

Embodiment 36. The granule of any one of embodiments 33-35, wherein the granule core is essentially free of calcium oxide.

Embodiment 37. The granule of any one of embodiments 33-36, wherein the first coating comprises a polymer.

Embodiment 38. The granule of embodiment 37, wherein the first coating consists essentially of the polymer and the amorphous phase material including calcium oxide.

Embodiment 39. The granule of embodiments 37 or 38, wherein the polymer includes a silicone polymer or a silicone copolymer, or a silicone-acrylic copolymer.

Embodiment 40. The granule of any one of embodiments 3-39, wherein the granule further comprises a second coating overlying the first coating, the second coating including a polymer, or a color pigment, or a dye, or any combination thereof.

Embodiment 41. The granule of embodiment 40, wherein the second coating is essentially free of a biocidal agent.

Embodiment 42. The granule of embodiments 40 or 41, wherein the second coating consists essentially of the polymer.

Embodiment 43. The granule of any one of embodiments 40-42, wherein the polymer includes a silicone polymer, or a silicone copolymer.

Embodiment 44. The granule of embodiment 40, wherein the second coating includes the polymer and further comprises the amorphous phase material including calcium oxide.

Embodiment 45. The granule of embodiments 1 or 2, wherein the granule is free of a coating.

Embodiment 46. The granule of any one of embodiments 3-39, wherein an amount of the calcium oxide in the first coating is at least 3 wt % based on the total weight of the first coating, or at least 5 wt %, or at least 7 wt %, or at least 10 wt %, or at least or at least 12 wt %, or at least 14 wt %, or at least 16 wt %, or at least 18 wt %, at least 20 wt %.

Embodiment 47. The granule of embodiment 46, wherein an amount of the calcium oxide in the first coating is not greater than 35 wt % based on the total weight of the first coating, or not greater than 30 wt %, or not greater than 25 wt %, or not greater than 20 wt %.

Embodiment 48. The granule of any one of embodiments 3-44, wherein the first coating has a total crystallinity of not greater than 30%, or not greater than 20%, or not greater than 10%, or not greater than 5%, or not greater than 2%.

Embodiment 49. The granule of embodiment 48, wherein the first coating has a total crystallinity of at least 1%, or at least 2%, or at least 5%.

Embodiment 50. The granule of any one of embodiments 3-44, wherein the first coating is fully amorphous.

Embodiment 51. The granule of any one of embodiments 3-44, wherein the first coating further comprises sodium silicate, clay, a pigment, a dispersing agent, a UV stabilizer, a hydrophobic agent, a fire retardant, or any combination thereof.

Embodiment 52. The granule of any one of embodiments 3-44, wherein an average thickness of the first coating is at least 5 microns, or at least 8 microns, or at least 10 microns, or at least 15 microns, or at least 20 microns, or at least 30 microns, or at least 40 microns, or at least 50 microns.

Embodiment 53. The granule of embodiment 52, wherein the average thickness of the first coating is not greater than 200 microns, or not greater than 150 microns, or not greater than 100 microns, or not greater than 80 microns, or not greater than 70 microns, or not greater than 60 microns.

Embodiment 54. The granule of any one of embodiments 3 to 44, wherein a size ratio of a diameter of the granule core to an average thickness of the first coating is at least 10, or at least 15, or at least 20.

Embodiment 55. The granule of embodiment 54, wherein the size ratio of the diameter of the granule core to the average thickness of the coating is not greater than 100, or not greater than 50, or not greater than 30, or not greater than 20.

Embodiment 56. The granule of any one of embodiments 3-44, wherein the granule further comprises a second coating overlying the first coating, the second coating including a polymer, a color pigment, a dye, or any combination thereof.

Embodiment 57. The granule of embodiment 56, wherein the polymer of the second coating includes a silicone polymer.

Embodiment 58. A method of forming a granule, comprising: preparing a green granule mixture, the green granule mixture comprising an amorphous material and an antibacterial agent including calcium oxide; forming a green granule body from the green granule mixture; and heating the green granule body to form the granule, wherein the granule comprises a 24-hour Ca²⁺ Leaching Factor (LF_{G}) of not greater than 1700 ppm.

Embodiment 59. A method of forming a granule, comprising: providing a granule core particle as a granule core; coating the granule core particle with a coating composition, the coating composition comprising an amorphous phase material and a biocidal agent including calcium oxide to form a green coated granule; heating the green coated granule to form a first coating attached to the granule core, wherein the granule comprises a 24-hour Ca²⁺ Leaching Factor of not greater than 1700 ppm.

Embodiment 60. The method of embodiments 58 or 59, wherein heating comprises firing the green coated granules at a temperature of at least 200° C., or at least 250° C., or at least 300° C., or at least 350° C., or at least 400° C., or at least 450° C., or at least 500° C., or at least 550° C.

Embodiment 61. The method of embodiment 60, wherein heating is conducted by firing the green coated granules at a temperature not greater than 650° C., or not greater than 600° C., or not greater than 560° C.

Embodiment 62. The method of embodiment 59, wherein the coating composition comprises a polymer, and heating comprises curing the green granules at a temperature of at least 60° C., or at least 80° C., or at least 100° C., or at least 130°.

Embodiment 63. The method of embodiment 62, wherein curing is conducted at a temperature not greater than 300° C., or not greater than 250° C., or not greater than 200° C., or not greater than 150° C.

Embodiment 64. The method of any one of embodiments 58-63, wherein the granule core comprises a ceramic particle or a mineral base rock particle.

Embodiment 65. The method of embodiment 64, wherein a material of the mineral base rock particle is selected from rhyolite, nepheline syenite, slate, basalt, andesite, dacite, diabase, granite, or any combination thereof.

Embodiment 66. The method of any one of embodiments 59-65, wherein the granule core further comprises a pigment coating overlying the ceramic particle or mineral base rock particle.

Embodiment 67. A building component comprising: a support layer;
an organic coating layer overlying the support layer; and a plurality of granules attached to the organic coating layer, wherein at least 10 vol % of the plurality of granules comprise a mixture, the mixture comprising an amorphous phase material and a biocidal agent including calcium oxide, and wherein the building component has an algae growth factor 90 (AGF 90) of between −50% and +30% according to a test in an algae growth chamber, with AGF 90=((delta E90_{S}/delta E90_{b-ref})−1)×100%, wherein delta E 90_{S} is delta E of the building component after 90 days exposure in the algae growth chamber, and delta E 90_{b-ref} is delta E of a biocidal test reference after 90 days exposure in the algae growth chamber, wherein 10 vol % of a plurality of granules of the biocidal test reference are granules containing 3.5 wt % Cu₂O as a biocidal agent.

Embodiment 68. A building component comprising: a support layer; an organic layer overlying the support layer; and a plurality of granules attached to the organic coating layer, wherein at least 10 vol % of the plurality of granules comprise a mixture, the mixture comprising an amorphous phase material and a biocidal agent including calcium oxide, and wherein the at least 10 vol % of the plurality of granules comprise a 24-hour Ca²⁺ leaching factor of not greater than 1700 ppm.

Embodiment 69. The building component of embodiments 67 or 68, wherein the plurality of granules comprises a first plurality of granules and a second plurality of granules, and wherein the first plurality of granules comprises the amorphous phase material and the biocidal agent including calcium oxide.

Embodiment 70. The building component of embodiment 69, wherein a weight percent ratio of the first plurality of granules to the second plurality of granules is not greater than 1:1, or not greater than 1:2, or not greater than 1:3, or not greater than 1:5, or not greater than 1:8, or not greater than 1:10.

Embodiment 71. The building component of any one of embodiments 69-70, wherein a weight percent ratio of the first plurality of granules to the second plurality of granules is at least 1:20, or at least 1:15, or at least 1:10.

Embodiment 72. The building component of any one of embodiments 67-71, wherein the building component has an E. coli reduction activity according to ASTM E2180 of at least 80%.

Embodiment 73. The building component of any one of embodiments 67-72, wherein the granules comprising the amorphous phase material and the biocidal agent including calcium oxide comprise a granule core and a first coating overlying the granule core, and wherein the first coating comprises the mixture comprising the amorphous phase material and the biocidal agent including calcium oxide.

Embodiment 74. The building component of any one of embodiments 67-73, wherein the plurality of granules is essentially free of a copper compound.

Embodiment 75. The building component of any one of embodiments 67-74, wherein the plurality of granules is essentially free of a silver compound.

Embodiment 76. The building component of any one of embodiments 67-75, wherein the plurality of granules is essentially free of a zinc compound.

Embodiment 77. The building component of any one of embodiments 67-76, wherein the plurality of granules is essentially free of a copper compound, essentially free of a silver compound, and essentially free of a zinc compound.

Embodiment 78. The building component of embodiment 67, wherein the AGF 90 is at least −40%, or at least −30%, or at least −20%, or at least −10%, or at least 1%, or at least 5%, or at least 10%, or at least 15%, or at least 20%.

Embodiment 79. The building component of embodiment 78, wherein the AGF 90 is not greater than 28%, or not greater than 26%, or not greater than 24%.

Embodiment 80. The building component of any one of embodiments 67-79, wherein the plurality of granules comprising the amorphous phase material and the biocidal agent including calcium oxide include the granule of any one of embodiments 1-57.

Embodiment 81. A method of forming a building component, comprising: applying on a support layer an organic coating layer; attaching to the organic coating layer a plurality of granules, wherein at least 10 vol % of the plurality of granules comprise a mixture, the mixture comprising an amorphous phase material and a biocidal agent including calcium oxide, and wherein the at least 10 vol % of the plurality of granules comprise a 24-hour Ca²⁺ leaching factor of not greater than 1700 ppm.

Embodiment 82. The method of embodiment 81, wherein the plurality of granules comprising a first plurality of granules and a second plurality of granules, and wherein the granules of the first plurality of granules comprise the amorphous phase material and a biocidal agent including calcium oxide.

Embodiment 83. A building component, comprising: a support layer; an organic layer overlying the support layer; a layer of a plurality of granules attached to the organic coating layer, and a functional layer overlying the layer of the plurality of granules, the functional layer comprising an amorphous phase material and a biocidal agent including calcium oxide, wherein the building component has an algae growth factor 90 (AGF 90) of between −50% and +30% according to a test in an algae growth chamber, with AGF 90=((delta E 90_{S}/delta E90_{b-ref})−1)×100%, wherein delta E 90_{S} is delta E of the building component after 90 days exposure in the algae growth chamber, and delta E 90_{b-ref} is delta E of a biocidal test reference after 90 days exposure in the algae growth chamber, wherein 10 vol % of a plurality of granules of the biocidal test reference are granules containing 3.5 wt % Cu₂O as a biocidal agent and the biocidal test reference does not contain the functional coating layer.

Embodiment 84. A building component, comprising: a support layer; and a functional layer overlying at least partially the support layer, the functional layer comprising an amorphous phase material and a biocidal agent including calcium oxide, wherein the building component has an algae growth factor 90 (AGF 90) of between −50% and +30% according to a test in an algae growth chamber, with AGF 90=((delta E 90_{S}/delta E 90_{b-ref})−1)×100%, wherein delta E 90_{S} is delta E of the building component after 90 days exposure in the algae growth chamber, and delta E 90_{b-ref} is delta E of a biocidal test reference after 90 days exposure in the algae growth chamber, wherein a functional layer of the biocidal test reference contains 3.5 wt % Cu₂O as a biocidal agent.

Embodiment 85. The building component of embodiments 83 or 84, wherein the functional layer is essentially free of a copper compound, essentially free of a silver compound, and essentially free of a zinc compound.

Embodiment 86. The building component of any one of embodiments 83-85, wherein an amount of the calcium oxide in the functional layer is at least 5 wt % based on the total weight of the functional layer, or 7 wt %, at least 10 wt %, at least 12 wt %, or at least 16 wt %, or at least 18 wt %, or at least 20 wt %.

Embodiment 87. The building component of any one of embodiment 83-86, wherein an amount of the calcium oxide in the functional layer is not greater than 35 wt % based on the total weight of the functional layer, or not greater than 30 wt %, or not greater than 25 wt %, or not greater than 20 wt %, or not greater than 15 wt %, or not greater than 10 wt %.

Embodiment 88. The building component of embodiment 83, wherein the plurality of granules is essentially free of a biocidal agent.

The following non-limiting examples illustrate the concepts described herein.

### Example 1

### Preparing of Antimicrobial Granules.

Antimicrobial granules were prepared from an amorphous glass material (Ecobiocide from Advance Science and Technology), which had the following composition: CaO (18-20 wt %); SiO₂ (38-42 wt %); B₂O₃ (8-9 wt %); Na₂O (18-20 wt %); K₂O (0.5-0.7 wt %); Al₂O₃ (10-12 wt %); Fe₂O₃ (0.10-0.15 wt %); others (0.6-1.1 wt %). The granules of this examples are referred to as Sample G-S1.

The amorphous glass was milled to a median particle size of between about 5-45 microns.

The antimicrobial reduction activity of the obtained granules (hereinafter sample G-S1) was tested according to a modified ASTM E2149. The modification of ASTM E2149 included using a different type of E. Coli and a longer treatment time: the E. Coli used was American Type Culture Collection No. 11229 (instead of No. 25922), and the treatment time was 48 hours (instead of 24 hours).

A first comparative sample (G-C1) was tested with Sample G-S1. The granules of Sample G-C1 were commercial roofing granules, which contained 3.5 wt % copper oxide in an outer coating and no further biocidal agent. The granules were 7000 Series copper granules.

A summary of the test results is shown in Table 1.

TABLE 1
Summary of ASTM E2149 test results on granules.

| | | Antimicrobial |
|---|---|---|
| | | Reduction |
| Sample | Biocidal agent | Activity [%] |
| G-S1 | CaO | 99.90 |
| G-C1 | Cu₂O | 98.90 |

### Example 2

Antimicrobial Reduction Activity of Shingles Covered with CaO Based Granules.

The granules from Sample G-S1 were mixed with standard roofing granules not containing a biocidal agent (made by CertainTeed Roofing) to obtain a plurality of granules (herein also called granule mixture). Two granule mixtures were made: 1) a granule mixture wherein the weight ratio of the G-S1 granules to the standard roofing granules in the granule mixture was 1:9 (10 wt % G-S1 granules), and 2), a mixture with a weight ratio of the G-S1granules to the standard roofing granules was 2:8 (20 wt % G-S1 granules).

A comparative granule mixture was prepared which contained 10 wt % of the G-C1 granules and 90 wt % of the standard roofing granules not containing a biocidal agent.

Exemplary building product samples were prepared by coating a polycarbonate substrate (5 cm×12.5 cm) with a bituminous layer. To the bituminous coated substrate, a mixture of the granules as added to coat the upper major surface of the bituminous layer with the granule mixture until the upper major surface was substantially covered.

The antimicrobial reduction activity of the building product samples was tested according to ASTM E2180 for the reduction of Escherichia coli (ATCC No. 11229) and the reduction of Staphylococcus aureus (ATCC No. 6538) after a treatment time of 48 hours.

The results of the ASTM E2180 testing are summarized in Table 2.

TABLE 2
Summary of ASTM E2180 test results on shingles

| | | Weight % of | E. coli | S. aureus |
|---|---|---|---|---|
| | Type of biocidal | biocidal granules | Reduction | Reduction |
| Sample | agent in granule | in granule mixture | Activity | Activity |
| S-S1 | CaO | 10 | 97.9% | 99.7% |
| S-S2 | CaO | 20 | 99.9% | 99.9% |
| S-C1 | Copper | 10 | 68.7% | 99.9% |
| | oxide | | | |

### Example 3

### Preparation of Coated Granules Containing Calcium Oxide as a Biocidal Agent in the Coating.

Base rock particles having a median particle size of about 0.5 mm to 2.0 mm were coated with a coating composition containing (per dry weight): 68-72 wt % of the CaO containing glass material of Example 1 (post milling), which corresponds to an CaO amount of 13.3 wt % to 14.0 wt % based on the total weight of the coating. The coating composition further contained 19-22 wt % sodium silicate, 5-6 wt % clay, 2.5-3.5 wt % titanium dioxide, and 0.01-0.1 wt % other pigments. The sodium silicate was provided as a 40 wt % liquid solution of silicate in water (water glass). The sum of the coating composition components (dry weight) is equal to 100 wt %.

The coating was conducted by combining the base rock particles to be coated in a rotating drum, wherein the base rock particles contributed 80-95 wt %, and the coating composition contributed 5-15 wt % (dry weight), based on the total dry weight of the base rock particles and the coating composition. After thorough mixing, the coated particles were heated and mixed while holding at a temperature of 70° C. until the particles were dried.

Thereafter, the dry coated granules (herein also called “green coated granules”) were fired at a maximum temperature of 550-565° C. for 30 minutes, and thereafter allowed to freely cool down.

The obtained granules were divided into two parts (first part and second part). The first part of granules was not further modified and is called herein sample G-S2, while the second part of the granules was subjected to a sintering treatment up to a temperature of 710° C. The sintering was conducted by heating the granules to a temperature of 650° C., holding the temperature for three hours at 650° C., followed by heating up to 710° C. and holding the temperature at 710° C. for three hours, followed by free cooling. The obtained sintered granules are called herein G-C2.

Another sample of coated granules (Sample G-C3) was prepared the same way as the granules G-S2 and G-C2 described above, except that the source for the calcium oxide was a crystalline calcium oxide powder (product No. 10317, from Carmeuse). The CaO powder contained about 89 wt % crystalline CaO. The coating composition (herein also called “coating composition 2” contained the following ingredients: 20-21 wt % CaO; 42-45 wt % sodium silicate, 23-25 wt % clay, 11-12 wt % titanium dioxide, and 0.1-0.3 wt % other pigments.

After conducting the coating, firing at a temperature of 565° C. was conducted for 30 minutes, followed by free cooling to obtain the coated granules G-C3. The thickness of the coatings for all coated granules samples (G-S2, G-C2, and G-C3) was about 30-40 microns.

The coated granules G-S2, G-C2, and G-C3 were tested regarding the leaching of calcium ions (Ca²⁺).

For the testing of the Ca²⁺ ion leaching, 10 g of the granules to be tested were added to a glass container filled with 950 ml of an aqueous buffer solution having a pH of 5.4 (using as buffer the combination of sodium hydroxide and acetic acid). The container was placed in an oven preheated to a temperature of 45° C. This temperature was maintained during the whole test, while the granules were slightly agitated in the buffer solution. During the test, the Ca²⁺-ion content in the buffer solution was measured via inductive coupled plasma OES (ICP-OES) after 24 hours (LF-24 h), 48 hours (LF-48 h), 72 hours (LF-72 h), 96 hours (LF-96 h), and 264 hours (LF-264 h) to obtain the cumulative amount of calcium ions released from the 10 g coated granules into the buffer solution. For each ICP test, 5 ml sample was taken from the container at the defined times, diluted to 50 ml with 10 vol % hydrochloric acid solution and directly analyzed by ICP-OES. The term “Ca²⁺ Leaching Factor” used herein is a normalized value of the measured amount of Ca²⁺ ions during the leaching test and refers to the amount of Ca²⁺ ions released by 1 gram granules with the unit ppm. Another way of expressing the Ca²⁺ Leaching Factor can be by the unit mg/g. For example, the 24 hour Ca²⁺ LF of sample G-S2 of 210 ppm corresponds to a value of 0.21 mg/g. The results of the measured Ca²⁺ Leaching Factors are shown in Table 3.

It can be seen from the data in Table 3 that subjecting the granules to sintering at a temperature of 710° C. (sample G-C2) caused a large increase in the Leaching Factor. For example, the 24-hour Ca²⁺ Leaching Factor Change (24-LF Change) between sample G-S2 and comparative sample G-C2 is about 1104.76%, an about 11 times increase of the Leaching Factor.

TABLE 3

| | | | LF G-C3 [ppm] |
|---|---|---|---|
| | | LF G-C2 [ppm] | (crystalline CaO |
| | LF G-S2 | (G-S2 sintered | powder used in |
| hours | [ppm] | at 710° C.) | coating composition) |
| 24 | 210 | 2320 | 1800 |
| 48 | 380 | 4330 | 2800 |
| 72 | 500 | 6460 | 2900 |
| 96 | 600 | | 3000 |
| 264 | 1200 | | 3100 |

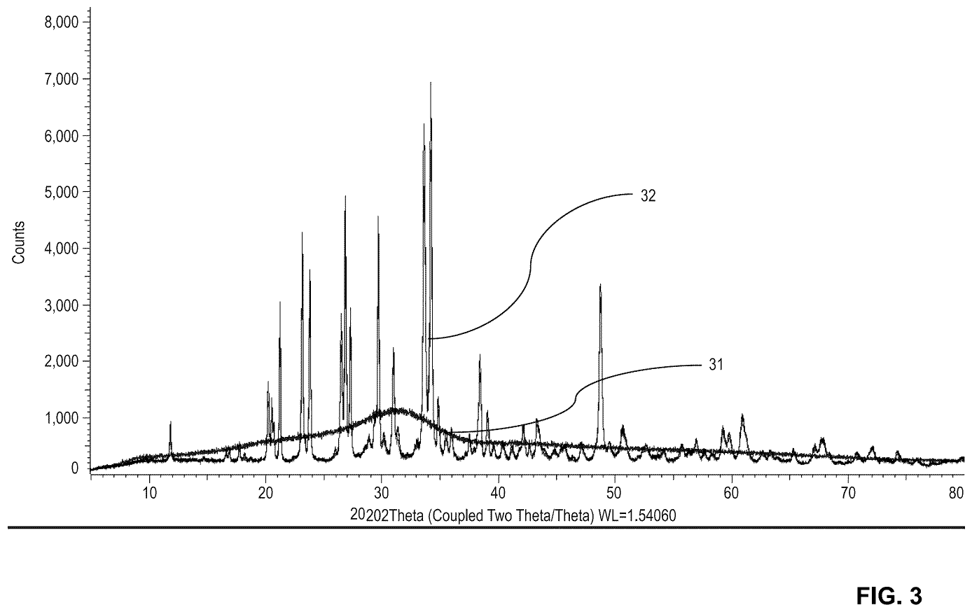

Without wishing to be bound to a particular theory, it appears that the increase of the Ca²⁺ Leaching Factor by sintering the granules at 710° C. is caused by a change of the amorphous character of the CaO containing glass material contained in the coating to a more crystalline character. As illustrated in the X-ray spectra shown in FIG. 3, the original CaO-enriched glass material (31) used as coating ingredient was fully amorphous, while subjecting the CaO-containing glass to heat-treatment at 710° C. caused a conversion of the amorphous material (31) to a highly crystalline material (32). It appears that the change from amorphous phase to crystalline phase allows a much easier release of Ca²⁺ ions from the coating.

The data of the Ca²⁺ ion leaching experiments obtained for granules G-C3, which were made by using as source for the calcium oxide an 89 wt % crystalline CaO powder, were similar to the data for sample G-C2. Not being bound to theory, this indicates that the selected binder system of the G-C3 granules is less efficient to keep the CaO within the coating matrix in comparison to the CaO contained in the amorphous phase material of granules G-S1.

### Example 4

Coated granules (G-S3) have been prepared the same way as in Example 3, except that the CaO containing glass was Frit F612/19 glass, hereinafter called “G 612,” in an amount of about 54-56 wt % based on the total weight of the coating.

The exact composition of G 612 is: K₂O: 3.5%, Na₂O: 4.5%, CaO: 12.0%, Al₂O₃: 10.0%, B₂O₃: 15.5%, SiO₂: 54.5%. It was confirmed via X-ray spectroscopy that the used G 612 glass is amorphous.

Before preparing the coating composition, the G 612 glass was treated the same way as the Ecobiocide glass of Example 1 by milling it to granules having a medium size of 5 to 45 microns.

Since the amount of CaO in G 612 is about 12 wt % and the amount of G 612 in the coating was 54-56 wt %, this corresponds to an amount of 6.5 to 6.7 wt % CaO in the coating of granule sample G-S3 based on the total weight of the coating.

Furthermore, coated granules have been prepared (G-S4) the same way as G-S3, except that 54-56 wt % of the CaO containing glass material of Example 1 was used in the coating, which corresponded to a CaO amount of 10.5 wt % to 10.9 wt % based on the total weight of the coating.

To show the influence of sintering at 710° C., a portion of granule sample G-S4 was subjected to sintering by heating the granules to 650° C., keeping the temperature for 3 hours at 650° C., and further heating the granules to 710° C. and holding the temperature for 3 hours at 710° C., followed by free cooling to room temperature. These obtained sintered granules are called herein comparative granule sample G-C4.

The granules of samples G-S3 and G-S4, and comparative sample G-C4 were subjected to the Ca²⁺ leaching test as described in Example 3. The results can be seen in Table 4.

TABLE 4

| | | | LF G-C4 [ppm] |
|---|---|---|---|
| | LF G-S3 | LF G-S4 | (G-S4 sintered |
| hours | [ppm] | [ppm | at 710° C.) |
| 24 | 120 | 363 | 1970 |
| 34 | 137 | 475 | 2340 |
| 48 | 160 | 652 | 3030 |
| 176 | 220 | 1470 | 4080 |
| 288 | 281 | 1830 | 4110 |
| 432 | 327 | 2190 | 4420 |

As can be seen in Table 4, the Ca²⁺ leaching of the granules of sample G-S3 (containing G 612 as CaO source) was lower than the Ca²⁺ leaching from granules G-S4, while both granule types contained the same wt % amount of an amorphous glass material containing CaO. Not being bound to theory, the lower amount Ca²⁺ leaching of the granules G-S3 containing G 612 in the coating may be caused by the lower content of CaO in G 612 (12 wt %) compared to the amount of CaO in Ecobiocide (18-20 wt %) used in the coating for granules G-S4.

It can be further seen in Table 4, that sintering the granules G-S4 at a temperature of 710° C. caused a strong increase in the Ca²⁺ leaching, see sample G-C4. The calculated 24-hour Ca2+ leaching factor change (24-LFA Change) by comparing samples G-S4 and G-C4 according to above-described equation (1) is 543 percent.

Another way of expressing the leaching of Ca²⁺ ions during the leaching test is calculating the total loss of the weight of the Ca²⁺ ions in the granule based on the leaching factor measurements. An example for such calculations is given in Table 5, wherein the weight-loss of Ca²⁺ ions of the granules is expressed in wt % based on the total weight of Ca²⁺ in the original granules, and otherwise corresponds to Table 4 regarding the measured Ca²⁺ leaching factors for these samples.

TABLE 5

| | | | G-C4 |
|---|---|---|---|
| | | | (G-S4 sintered |
| hours | G-S3 | G-S4 | at 710° C.) |
| 24 | 1.22% | 2.27% | 12.33% |
| 34 | 1.39% | 2.97% | 14.64% |
| 48 | 1.63% | 4.08% | 18.96% |
| 176 | 2.24% | 9.20% | 25.53% |
| 288 | 2.86% | 11.45% | 25.72% |
| 432 | 3.33% | 13.70% | 27.66% |

### Example 5

Leaching test of granules containing amorphous CaO containing glass material in a polymer-coating.

Coated base-rock granules (sample G-S5) have been prepared the same way as described in Example 3 for sample G-S2, except that the coating material contained next to 55 wt % of the CaO-containing glass an amount 45 wt % of a water-based silicone copolymer from PPG.

After the coating composition was applied on the base rock particles, the green coated particles were cured for one hour at a temperature of 130° C. and mixed several times during curing, wherein curing included to large extent drying (removing of the water). The thickness of the coating after curing was about 30-40 microns.

A further comparison was made by conducting the Ca²⁺ leaching test with granules formed from the CaO-containing glass material described in Example 1 (Exobiocide), which did not contain a coating, and were sieved to obtain a size fraction between 595 and 1680 microns, sample G-S6. Comparative granules (G-C5) have been made by subjecting the granules G-S6 to the above-described sintering at 710° C.

The results of the Ca²⁺ leaching test is shown in Table 6. It can be seen that the Ca²⁺ leaching factor for the polymer-coated granules (sample G-S5), which contained the amorphous CaO material in a silicone copolymer coating was similar as the Ca²⁺ leaching factor for granules of which the complete body was formed of the CaO-containing glass material and not coated (sample G-S6). However, if the Ca²⁺ leaching amount is compared with the granules containing a ceramic coating (see samples G-S2, G-S3, and G-S4 in Tables 3 and 4) the leaching of the granules containing the CaO glass in the polymer coating (sample G-S5) was higher.

TABLE 6

| | LF G-S5 [ppm] | LF G-S6 [ppm] | |
|---|---|---|---|
| | (CaO in silicone | (uncoated CaO- | LF G-C5 [ppm] |
| | copolymer | containing | (G-S6 sintered |
| hours | coating) | granules) | at 710° C.) |
| 24 | 1610 | 1680 | 4240 |
| 34 | 1930 | 2180 | 4870 |
| 48 | 2830 | 2860 | 6240 |
| 176 | 4110 | 4190 | 11900 |
| 288 | 4420 | 4500 | 13400 |
| 432 | 4740 | 4740 | 13600 |

It can be further seen from the data in Table 5 that the Ca²⁺ leaching was very high if the uncoated CaO-containing granules G-S1 were subjected to sintering at 710° C. The calculated 24-hour Ca²⁺ leaching factor change (LF Change) between samples G-S6 and G-C5 is 252 percent.

### Example 6

### Testing the Ability of Algae Growth Inhibition of Shingles in Algae Growth Chamber

Test-shingles (TS-S1) (herein also called building components) were prepared containing the above-described coated granules G-S2 as an upper layer and subjecting the test shingles to three months treatment in an algae growth chamber. The algae growth on the test shingles TS-S1 was compared with the algae growth on test shingles having an upper layer of granules which contain Cu₂O in the coating, a known biocidal agent, as a reference, and being called TS_{b-ref}. Another reference was used by making testing at the same time shingles which contained as upper layer granules which did not contain a biocidal agent, being called TS_{non-b ref}.

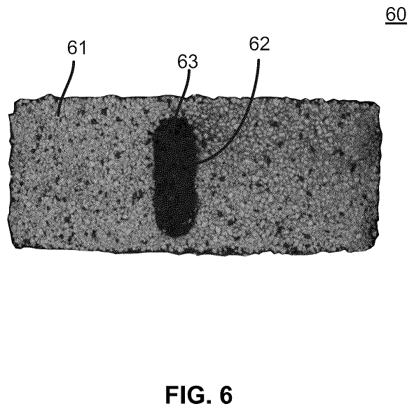

All test shingles had a size of inches length and 2.25 inches width and contained as an upper outer layer a single layer of granules (61), see also FIG. 6.

The granules (61) to be tested were attached onto a heated and tacky asphalt patty on a support. In the center of the test shingle was kept an opening (62) having a size of about one inch length and half inch width, into which algae seeds (63) were placed and leveled with the outer surface of the granule layer. The Algae seeds were obtained from algae infested shingles from a farm in Tampa, Florida, which have been exposed for over 10 years to the outside weather conditions.

The test shingle (TS-S1) representative for the present disclosure was prepared by using as granules the granules of sample G-S2 (coated base rock granules containing in the coating the antibacterial agent CaO in an amount of 13.5-14.0 wt % CaO within an amorphous phase material).

The reference test shingle TS_{b-ref}, was prepared by using commercial granules containing copper oxide as a biocidal agent (7000 Series copper granules), which contained 3.5 wt % Cu₂O and pigments (CertainTeed PN: 412150). A granule mixture was prepared by combining 10 vol % of the Cu₂O-containing granules with 90 vol % commercial base rock granules containing a pigment coating (silver birch, CertainTeed, PN 412443), which did not contain a biocidal agent. The reference test shingle TS_{b-ref} was used as an internal standard representative to a commercially known biocidal shingle, herein also called “biocidal-reference” (b-ref).

The reference shingle not containing a biocidal agent, herein called TS_{non-b ref}, contained 100 vol % base rock granules containing a pigment coating (silver birch, CertainTeed, PN 412443) agent. The reference test shingle TS_{non-b} ref was used as internal standard for a shingle not containing a biocidal agent, herein also called “non-biocidal reference” (non-b ref.).

Attention was given to the selection of the pigment-coating of the non-biocidal base rock granules used for the reference shingles TS_{b-ref} and TS_{non-b ref} and the selection of the copper oxide containing granules, such that the color difference between test shingle TS-S1 and the reference test shingles TS_{b-ref} and TS_{non-b ref} was within a delta E of not more than 10, it was further ensured that the L* value was greater than 50 for all test shingles.

### Algae Growth Chamber Test

The algae growth chamber test was conducted in a self-constructed chamber having a height of about 28.5 inches, a length of about 20 inches, and a width of about 18.5 inches, and being built to run long-term test cycles (typically three to four months) wherein the test shingles are exposed to conditions that promote algae growth, while still being representative to real-world conditions.

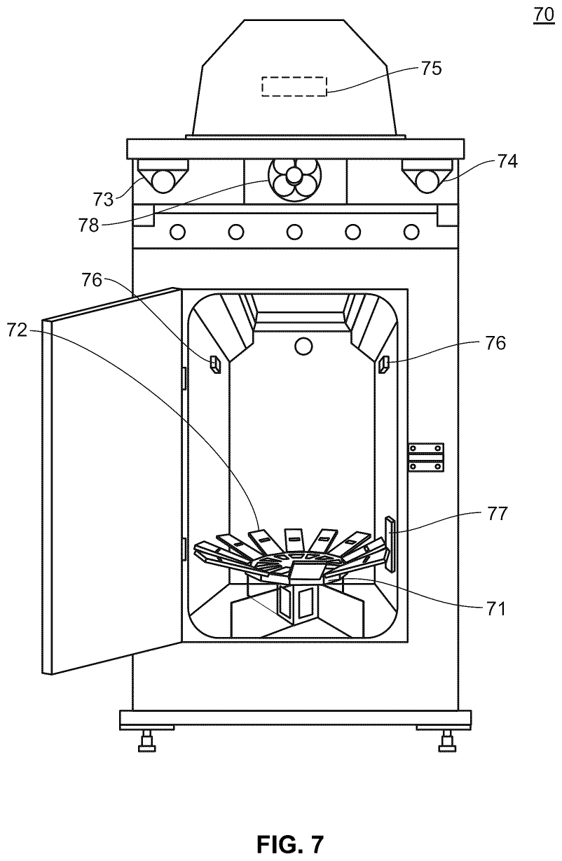

In the bottom region of the algae chamber (70) was placed a rotating holder (71) constructed to hold twelve test shingles (72) at the same time (see FIG. 7).

During operation of the algae growth chamber, the conditions were alternated every 12 hours between radiation with high-intensity UVA light (1.8 mW/cm2), UVB light (0.03 mW/cm3), and visible grow light (200 PPFD and 15000 Lux). The high intensity UVA light source (73) was a LED (E365-50-UVA LED) was positioned at the top of the algae growth center (70), together with a UV-B lamp (74) and a grow light emitting the visible light (75). A light fan (78) was further included to mix the light and the air within the chamber. The distance of the lamps (73, 74) to the test shingles (72) was about 22 inches, and the grow-light to the samples about 30 inches.

During the operation of the algae growth chamber, the test shingles were further sprinkled with once per day with Allen medium, once every 15 minutes during the day with distilled water, and once every hour during the night, using automatic pumps connected to misting nozzles (76).

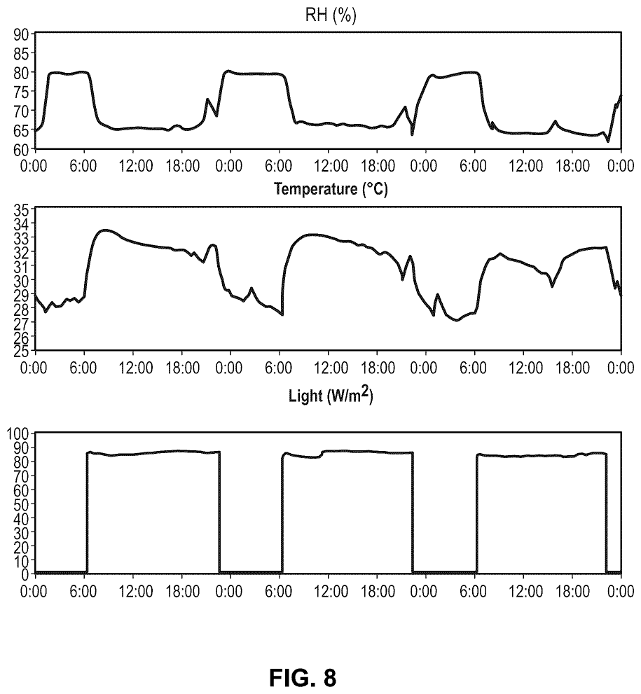

The overall control of the system was handled by a programmed industrial controller, using sensors (77) to control humidity, temperature, and light radiation. The temperature was regulated to be in a range between 25° C. and 40° C., the relative humidity between 60% and 90%, and it was insured that the light intensity was within the range of 75 W/m² to 100 W/m². A three day cycle of humidity, temperature, and light radiation is illustrated in FIG. 8.

For each sample, three shingles were prepared and tested via image analysis to determine the change in color and expressed as “delta E” value, by comparing the CIE L*a*b* values measured at the beginning of the algae chamber growth test and at a given test day/time (once every week) during the three months algae growth chamber test run. The sample imaging was conducted using a HPD2 200SW Dome Light from CCS Inc., a Basler Ace MV Camera, and software from SGRNA GitLab. The delta E values were calculated according to CIE standard Delta E2000 (CIEDE2000).

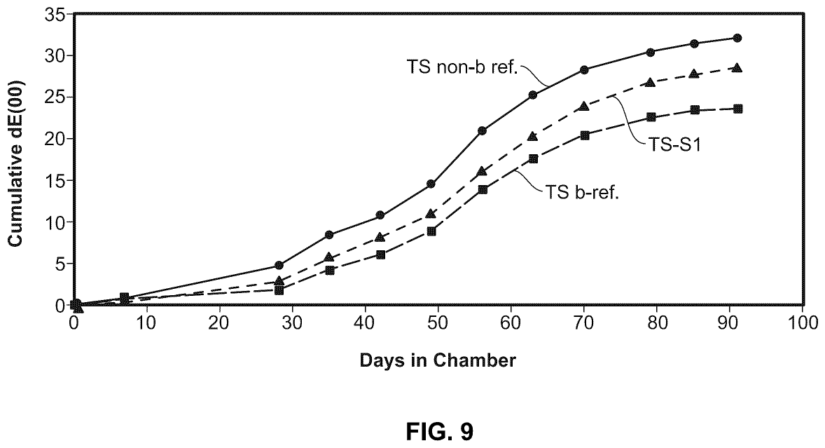

The results of the measured delta E values over a time period of 91 days is shown in FIG. 9. It can be seen that after 90 days, the delta E (dE) value for test shingle TS-S1 (dE=28) is clearly below the delta E value of the reference test shingle TS_{non-b ref.}, which did not contain a biocidal agent (dE=32). This means the coated granules containing CaO within an amorphous phase material in the coating have a biocidal activity. In comparison to the reference shingle TS_{b-ref} (dE=23), which contained granules having Cu₂O in the coating, the delta E for sample TS-S1 was higher. Expressing the difference of the delta E values between two samples after culturing the test shingles for 90 days in the algae growth chamber is called herein the “algae growth factor 90” (AGF 90). When comparing samples TS-S1 and TS_{b-ref}, the AGF 90 is calculated according to equation (2): AGF 90=((delta E 90_{S}/delta E90_{b-ref})−1)×100% (2), wherein delta E 90_{S} is delta E after 90 days exposure of the test shingle (TS-S1, with a measured value of dE=23), and delta E 90_{b-ref} is delta E after 90 days exposure of a test reference shingle (T_{b-ref}, with a measured value of dE=28), which arrives at an AGF 90 of 22.2 percent.

### Example 7

A building component (TS-S2) was made the same way as described in Example 6 for sample TS-S1, except that the granules used were the granules of sample G-S5, wherein the material of the granule coating (22) was a silicone polymer containing 55 wt % of calcium-oxide containing glass.

The testing conditions in the algae growth chamber were the same as in Example 6, as well as the reference test shingles TS_{b-ref}. (including copper oxide as biocidal agent) and TS_{non-b ref} (not including a biocidal agent).

Furthermore, another test shingle was prepared and tested, TS-S3, which contained the granules of sample G-C3, which contained crystalline calcium oxide added to the coating composition when forming the coating.

Table 7 shows the cumulative delta E values for samples TS-S2 and TS-S3, and of the reference shingles TS_{b-ref.} and TS_{non-b ref.} after 90 days exposure to the algae growth chamber test. It can be seen that delta E for sample TS-S2 was slightly lower than the delta E value after 90 days for the biocidal reference test shingle. The calculated AGF 90 was −3.6%, which means the biocidal activity was nearly the same as for the biocidal reference test shingle.

In contrast, test shingle TS-S3, which contained crystalline CaO within the coating was not lower in its delta E value than the non-biocidal reference, and much higher than the delta E of the biocidal reference. The AGF calculated for this sample was 78.6%. This high value indicates that sample TS-S3 had no biocidal activity. Not being bound to theory, a reason may be that the CaO was already leached from the coating under the test conditions within the algae growth chamber after 90 days.

TABLE 7

| | | Delta E | |
|---|---|---|---|
| Sample | Granule Coating | after 90 days | AGF 90 |
| TS-S2 | Silicone + amorphous | 13.5 | −3.6% |
| | CaO-glass | | |
| | (granules G-S5) | | |
| TS-S3 | Ceramic coating + | 25 | 78.6% |
| | crystalline CaO | | |
| | (granules G-C3) | | |
| TS_{b-ref.} | | 14.0 | n/a |
| TS_{non-b ref.} | | 25 | n/a |

### Example 8

A building component (TS-S4) is made as described in Example 6 for sample TS-S1, except that all the granules are the granules not containing a biocidal agent. After forming of the granule layer, the coating composition of Example 5 (for forming the polymer-coated granules G-S5) is applied as a thin layer with a thickness of about 30-40 microns covering all the granules. The board is cured at a temperature of 130° C. for one hour and allowed to cool (see FIG. 5B).

A sample of the obtained building board is subjected to the algae growth chamber test for 90 days as described in Example 6. The Delta E values are measured once every week and compared with the Delta E values of the biocidal reference test shingle (TS_{b-ref}) and the non-biocidal reference test shingle (TS_{non-b ref.}). Data are obtained which show that the test building component TS-S4 has a lower delta E than the reference board which does not contain a biocidal agent. The algae growth factor 90 (AGF 90) is calculated according to equation (2) and not greater than 30 percent.

### Example 9

A building component (TS-S5) is made as described in Example 6 for sample TS-S1, except that no granules are used but the coating composition is the silicone copolymer containing the amorphous calcium oxide containing glass (the same coating used for making the coating for the granule G-S5 of Example 5) and applied as a thin coating of 30-40 microns onto a polycarbonate board (substrate). The coated board was cured at a temperature of 130° C. for one hour and allowed to cool. A line drawing of the structure of the building board can be seen in FIG. 5A.

A sample of the obtained building board is subjected to the algae growth chamber test for 90 days as described in Example 6. Delta E values are measured once every week and compared with the Delta E values of a biocidal reference containing instead of the CaO glass 3.5 wt % Cu₂O in the coating (TS_{b-ref}) and a non-biocidal reference (TS_{non-b ref.}), wherein the coating does not contain the CaO glass and also no other biocidal agent. Data are obtained which show that the test building board TS-S5 has a lower delta E than the reference board which does not contain a biocidal agent. The algae growth factor 90 (AGF 90) is calculated according to equation (2) and not greater than 30 percent.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. A granule, the granule comprising a mixture, the mixture comprising an amorphous phase material and a biocidal agent including calcium oxide,
wherein a 24-hour Ca2+ leaching factor change of the granule (24-LF Change) is at least 10%, the 24-LF Change=(24-LF_{G710}/24-LF_{G})×100%, with 24-LF_{G} being a 24 hour Ca²⁺ leaching factor of the granule and 24-LF_{G710} being a 24 hour leaching factor of the granule after subjecting the granule to sintering for 3 hours at a temperature of 710° C.

2. The granule of claim 1, wherein the granule comprises a 24-hour Ca²⁺ Leaching Factor (LF_{G}) of not greater than 1700 ppm.

3. The granule of claim 1, wherein the calcium oxide is a part of the amorphous phase material.

4. The granule of claim 3, wherein the amorphous phase material includes a silica-based glass containing the calcium oxide.

5. The granule of claim 1, wherein the granule is essentially free of a copper compound, essentially free of a silver compound, and essentially free of a zinc compound.

6. The granule of claim 1, wherein the granule comprises a granule core and a first coating overlying the granule core, and wherein the first coating comprising the amorphous phase material containing the calcium oxide.

7. The granule of claim 6, wherein the first coating further comprises at least one additive selected from sodium silicate, clay, titanium dioxide, aluminum trihydrate, a polymer, a pigment, a dye, a dispersant, or any combination thereof.

8. The granule of claim 6, wherein an amount of the at least one additive is at least 10 wt % based on the total weight of the coating.

9. The granule of claim 6, wherein an amount of the calcium oxide in the first coating is at least 3 wt % based on the total weight of the coating.

10. The granule of claim 6, wherein the first coating comprises a polymer and the amorphous phase material containing the calcium oxide.

11. The granule of claim 10, wherein the polymer is a silicone polymer or a silicone copolymer.

12. A granule, the granule comprising a mixture, the mixture comprising an amorphous phase material and a biocidal agent including calcium oxide, wherein the granule comprises a 24-hour Ca²⁺ Leaching Factor (LF_{G}) of not greater than 1700 ppm.

13. A method of forming a granule, comprising:
providing a granule core particle as a granule core;
coating the granule core particle with a coating composition to form a green coated granule, the coating composition comprising an amorphous phase material and a biocidal agent including calcium oxide;
heating the green coated granule to form a first coating attached to the granule core,
wherein the granule comprises a 24-hour Ca²⁺ Leaching Factor of not greater than 1700 ppm.

14. A building component comprising:
a support layer;
an organic coating layer overlying the support layer; and
a plurality of granules attached to the organic coating layer, wherein at least 10 vol % of the plurality of granules comprise a mixture, the mixture comprising an amorphous phase material and a biocidal agent including calcium oxide, and wherein the building component has an algae growth factor 90 (AGF 90) of between −50% and 30% according to a test in an algae growth chamber, with AGF 90=((delta E90_{S}/delta E90_{b-ref})−1)×100%, wherein delta E 90_{S} is delta E of the building component after 90 days exposure in the algae growth chamber, and delta E90_{b-ref} is delta E of a biocidal test reference after 90 days exposure in the algae growth chamber, wherein 10 vol % of a plurality of granules of the biocidal test reference are granules containing 3.5 wt % Cu₂O as a biocidal agent.

15. A building component comprising:
a support layer;
an organic layer overlying the support layer; and
a plurality of granules attached to the organic coating layer,
wherein at least 10 vol % of the plurality of granules comprise a mixture, the mixture comprising an amorphous phase material and a biocidal agent including calcium oxide, and wherein the at least 10 vol % of the plurality of granules comprise a 24-hour Ca²⁺ leaching factor of not greater than 1700 ppm.

16. The building component of claim 14, wherein the plurality of granules comprises a first plurality of granules and a second plurality of granules, and wherein the first plurality of granules comprises the amorphous phase material including the calcium oxide.

17. The building component of claim 16, wherein a weight percent ratio of the first plurality of granules to the second plurality of granules ranges from 1:1 to 1:20.

18. The building component of claim 14, wherein the plurality of granules is essentially free of a copper compound, essentially free of a silver compound, and essentially free of a zinc compound.

19. The building component of claim 18, wherein the building component has an E. coli reduction activity according to ASTM E2180 of at least 80%.

20. A method of forming the building component of claim 14, comprising:
applying on the support layer the organic coating layer; and
attaching to the organic coating layer the layer of the plurality of granules.
